(19) United States
(12) Patent Application Publication
(10) Pub. No.: US 2010/0085970 A1
(43) Pub. Date: Apr. 8, 2010

(54) METHOD AND APPARATUS FOR PROVIDING MULTICAST COMMUNICATION

(75) Inventors: Aviv Barkan, Bat Hefer (IL); Barak Hamou, North (IL); Danny Zadok, Rishon Le Zion (IL)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/530,248

(22) PCT Filed: May 29, 2008
(86) PCT No.: PCT/US08/65031

§ 371 Date: Sep. 8, 2009

(30) Foreign Application Priority Data
Jun. 6, 2007 (GB) 0710838.4

(51) Int. Cl. H04L 12/56

(52) U.S. Cl. 370/392

(57) ABSTRACT

A method of providing multicast communication between a home domain and a mobile device visiting a foreign domain comprises receiving a request to participate in a multicast session from the mobile device and registering the mobile device, from which the request was received, with a sub-session associated with the requested multicast session. The method further comprises providing details of the sub-session to the mobile device; and upon subsequent receipt of a multicast packet corresponding to the multicast session, encapsulating the received multicast packet within a sub-session packet, the sub-session packet comprising the sub-session address as its destination address, and sending the sub-session packet to a care-of address for the mobile device.

### TECHNICAL FIELD

The technical field relates generally to a method and apparatus for providing multicast communication, and more particularly to a method and apparatus for providing multicast communication between a home domain and a mobile device visiting a foreign domain.

### BACKGROUND

As mobile computing becomes increasingly important, there is an increasing need for continuous network connectivity to, for example, the Internet or core enterprise networks (CENs), irrespective of the physical location of a mobile computing device.

As is well known, the Internet infrastructure relies upon a collection of protocols, collectively known as the Transmission Control Protocol/Internet Protocol (TCP/IP) protocol suite. The core protocols within the TCP/IP protocol suite are the Transmission Control Protocol (TCP) and the Internet Protocol (IP). IP requires the location of a device connected to the Internet to be uniquely identified by an assigned IP address, the standards for which are defined in RFC 1166.

Mobile computing devices are able to connect to, for example, the Internet by establishing a connection with an intermediate local network or the like. The local network subsequently assigns an IP address to a mobile device, and provides connectivity to the Internet etc. through the local network.

As will be appreciated, when the mobile device moves location, it may be necessary for the mobile device to establish a new connection with a new local network. Consequently, the mobile device will be assigned a different IP address. However, it is often the case that higher-level protocols require the IP address of a mobile device to be fixed for identifying connections.

To overcome this problem, the Mobile Internet Protocol (MIP) was developed. MIP is an extension to IP, and is defined in the IPv4 standard. MIP is defined in RFC 3344.

MIP provides for a mobile device to be associated with a ‘home’ domain, for example a core enterprise network (CEN). The mobile device is accordingly assigned a home address within the home domain. The home domain comprises a mobility management agent or home agent (HA).

When a mobile device visits an intermediate domain or ‘foreign’ domain, as previously mentioned, the foreign domain assigns an IP address to the roaming mobile device, known as a care-of-address. The foreign domain also comprises a mobility management agent, or foreign agent (FA). The mobile device notifies the HA of the IP address of the FA, and also notifies the FA of its home address and care-of address.

In this manner, when the HA receives a data packet addressed to the home address of the mobile device, it formulates an MIP packet addressed to the FA, and encapsulates the received data packet therein. The HA then forwards the MIP packet to the FA. Upon receipt of the MIP packet, the FA decapsulates it and extracts the original packet. The FA then determines the address to which the data packet was destined, i.e. the home address of the mobile device, and formulates a further data packet addressed to the care-of address of the mobile device, and encapsulates the original data packet therein, and forwards it to the mobile device. The mobile device is then able to decapsulate this further data packet to retrieve the original packet. Thus, data packets addressed to the home address of the mobile device are forwarded to the mobile device at its current care-of address.

In this manner, for higher-level protocols, the home address of the mobile device remains constant, whilst allowing mobile connectivity for the mobile device.

The inventor has identified a problem in relation to current methods for providing mobile connectivity, in particular in relation to transmission and reception of secure multicast packets.

As is known, a mobile device is able to participate in a multicast session within their home domain by way of a multicast IP address, arranged to be locally unique to the home domain, even when visiting a foreign domain. Multicast packets relating to a particular multicast session comprise a destination address set as the relevant multicast IP address for that multicast session. Accordingly, when a home agent receives multicast packets having as their destination address the multicast IP address of a multicast session for which a mobile device has registered, the home agent is able to forward the multicast packets to the mobile device via the care-of address of the mobile device.

For a mobile device, visiting a foreign domain, to participate in such a multicast session, the mobile device sends a ‘join’ message to the HA, via the FA. In this manner, the HA and FA register the multicast address for the particular multi-cast session to be joined in relation to the mobile device. Consequently, in the same way as for a data packet addressed to the home address of the mobile device, a data packet addressed to the multicast address will be forwarded to the mobile device at its current care-of address.

In this manner, where a plurality of mobile devices, visiting the same foreign network, are participating in the same multicast session, the HA is only required to send a multicast data packet once to the FA, with the FA forwarding the multicast data packet to each mobile device.

Security is often a requirement for packets of data being transmitted, in particular for packets of data being transmitted outside of a home domain, for example to a mobile device visiting a foreign domain. Consequently, it is known for mobile management agents, e.g. home agents and foreign agents, to encrypt data packets prior to transmission, for example using the IPSEC security protocol defined in request for change document RFC 2401 (Security Architecture for the Internet Protocol), prior to encapsulating them in additional packets, such as MIP packets. In this way, a level of security is afforded to packets of data.

A problem arises when the mobile device moves from one foreign domain to another foreign domain. When switching foreign domains, the mobile device de-registers the initial care-of address with the HA, and then registers with the new FA, and informs the HA of its new care-of address. However, whilst the HA remains aware of the multicast session, of which the mobile device is participating, the new FA is unaware of the multicast session, since it never received the ‘join’ message. Consequently, although the HA will forward multicast packets to the FA, since the FA is unaware that the mobile device is participating in the multicast data session, it will not forward the multicast data packets to the mobile device.

One method to overcome this problem would be for the HA to forward multicast data packets individually to each mobile device participating in the multicast session, effectively encapsulating the multicast data packets within unicast data packets addressed to each of the mobile devices, such that foreign agents are able to identify to which mobile device that packet is destined. However, in a case where a plurality of mobile devices, visiting a single foreign network, is participating in a multicast session, there will be a significant increase in the amount of bandwidth consumed. As will be appreciated by a skilled artisan, this is undesirable due to the limited bandwidth available in the vast majority of mobile applications. Furthermore, such a solution would significantly increase the burden placed upon the HA.

A further problem with current implementations of multicast sessions is that multicast sessions are typically restricted to a local network, whereby routers of a local network do not forward multicast packets outside of the local network. In this manner, multicast groups are defined, and thereby unique, within a local network.

A consequence of this is that a multicast group defined in one local network may comprise the same multicast address as a multicast group defined in another local network. As will be appreciated by a skilled artisan, when a mobile device participating in a multicast session visits a foreign domain, there may be a conflict between the address of the multicast group of its home domain, and of which it is a member, and an address of a multicast group of the foreign domain.

This problem is exacerbated when a mobile device moves between foreign networks, since the likelihood of such a conflict between multicast addresses increases.

A further problem with the prior art is that, although a MIP tunnel between the HA and FA enables a level of security between the home and foreign networks, no such security is provided between the FA and the mobile device. In order to achieve this, it would be necessary for the multicast packet to be encapsulated within an additional tunnel between the HA and the mobile device. However, this would once again require the HA to send the multicast packet individually to each mobile device. As mentioned above, this is undesirable due to the increase in required bandwidth.

A yet further problem with the prior art is that it assumes that a foreign domain comprises a mobility management agent, i.e. an FA. However, it may be the case that a foreign domain simply comprises a router through which a mobile device is able to connect to, for example, the Internet. Although this router may support multicasting, it may not support MIP tunnelling, or similar security mechanisms. Consequently, although a mobile device visiting such a foreign domain may be able to register that it wishes to participate within a multicast session with the foreign router, the transmission of multicast data packets between the HA and the foreign router will not be secure.

Thus, there exists a need for a method and apparatus for providing multicast communication that addresses at least some of the shortcomings of past and present multicast mobile data communication techniques.

### BRIEF DESCRIPTION OF THE FIGURES

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 illustrates a communication system in accordance with an embodiment of the invention.

FIG. 2 illustrates a flow chart of a method of providing multicast communication in accordance with an embodiment of the invention.

FIG. 3 illustrates an example of a multicast data structure in accordance with an embodiment of the invention.

FIG. 4 illustrates a flow chart of a method of providing multicast communication in accordance with an embodiment of the invention.

FIG. 5 illustrates a flow chart of a method of providing multicast communication in accordance with an embodiment of the invention.

FIG. 6 illustrates a communication system in accordance with an embodiment of the invention.

FIG. 7 illustrates a communication system in accordance with an embodiment of the invention.

FIG. 8 illustrates a communication system in accordance with an embodiment of the invention.

FIG. 9 illustrates an example of a mobile device and a mobile management agent in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, there is provided a method and apparatus for providing multicast communication between a home domain and a mobile device visiting a foreign domain, the method comprising the steps of: receiving a request to participate in a multicast session from the mobile device; registering the mobile device, from which the request was received, with a sub-session associated with the requested multicast session; providing a sub-session address to the mobile device; and upon subsequent receipt of a multicast packet corresponding to the multicast session, encapsulating the received multicast packet within a sub-session packet, the sub-session packet comprising the sub-session address as its destination address, and sending the sub-session packet to a care-of address for the mobile device.

In one embodiment, the sub-session is a multicast session of a foreign domain, which may be created for the purpose of a sub-session associated with the requested multicast session.

In this manner, the sub-session address is independent of the address for the requested multicast session. Accordingly, a conflict between the address of the requested multicast session and that of a multicast session existing within the foreign domain may be avoided.

Those skilled in the art will realize that the above recognized advantages and other advantages described herein are merely illustrative and are not meant to be a complete rendering of all of the advantages of the various embodiments.

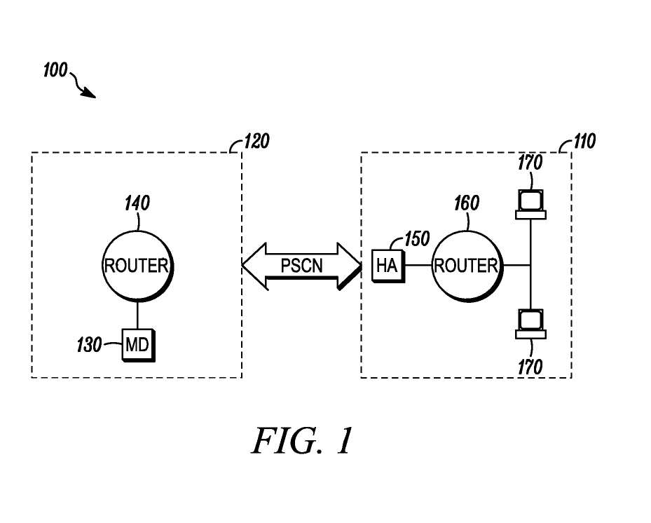

Referring now to the drawings, and in particular FIG. 1, a communication system in accordance with some embodiments is shown and indicated generally at 100. Those skilled in the art, however, will recognize and appreciate that the specifics of this example are merely illustrative of some embodiments and that the teachings set forth herein are applicable in a variety of alternative settings.

Turning now to FIG. 1, the communication system comprises a home domain 110, for example a core enterprise network (CEN), and a foreign domain 120. A mobile device 130, associated with the home domain 110 has roamed outside of the home domain 110 and, is connected to a foreign router 140 of the foreign domain 120, and as such is ‘visiting’ the foreign domain 120.

The mobile device 130 may be connected to the foreign router 140 by any suitable means, for example via a local area network (LAN), wireless LAN (WLAN), general packet radio service (GPRS), etc.

The home domain 110 comprises a mobility management agent, or home agent (HA) 150. For the illustrated embodiment, the HA 150 of the home domain 110 and the foreign router 140 of the foreign domain 120 are coupled to a public switched communication network (PSCN), for example the Internet, and accordingly are afforded connectivity therebetween.

As is known in the art, the mobile device 130 comprises a home address, assigned to it by the home domain 110. When a mobile device visits a foreign domain, such as the foreign domain 120, the foreign domain 120 assigns an IP address to the mobile device 130, known as a ‘care-of address’. The mobile device 130 registers its current location with the HA 150 by notifying the HA 150 of an address of the foreign router 140, and also registers with the foreign router 140 its ‘home address’ and its ‘care-of address’.

The mobile device 130 is able to participate in a multicast session within its home domain 110 using a multicast address, locally unique to, and generated by, the home domain 110, even when visiting a foreign domain, such as the foreign domain 120.

For the illustrated embodiment, when the mobile device 130 wishes to participate in a multicast session, that is to say become a member of a multicast group participating in a multicast session, the mobile device 130 sends a request to the HA 150 to join the multicast session. Such a request may form a part of a registration procedure, as mentioned above, or may comprise a separate procedure.

As will be appreciated by a skilled artisan, although only a single mobile device 130 is illustrated in FIG. 1, it is envisaged that more than one mobile device, associated with the home domain 110 may be visiting foreign domain 120. Furthermore, mobile devices associated with the home domain 110 may be visiting foreign domains other than foreign domain 120 of FIG. 1. Accordingly, the HA 150 may have one or more mobile devices, visiting one or more foreign domains, registered therewith.

Additionally, the various mobile devices registered with the HA 150 may request to join various multicast sessions. In particular, a plurality of mobile devices, visiting a plurality of foreign networks, may request to join a particular multicast session.

For each multicast session, for which the HA 150 receives one or more requests from mobile devices, the HA 150 registers details of that multicast session, for example the appropriate ‘multicast IP address’. The HA 150 then creates a sub-session for that multicast session, with which it associates each of the mobile devices requesting to participate in that multicast session.

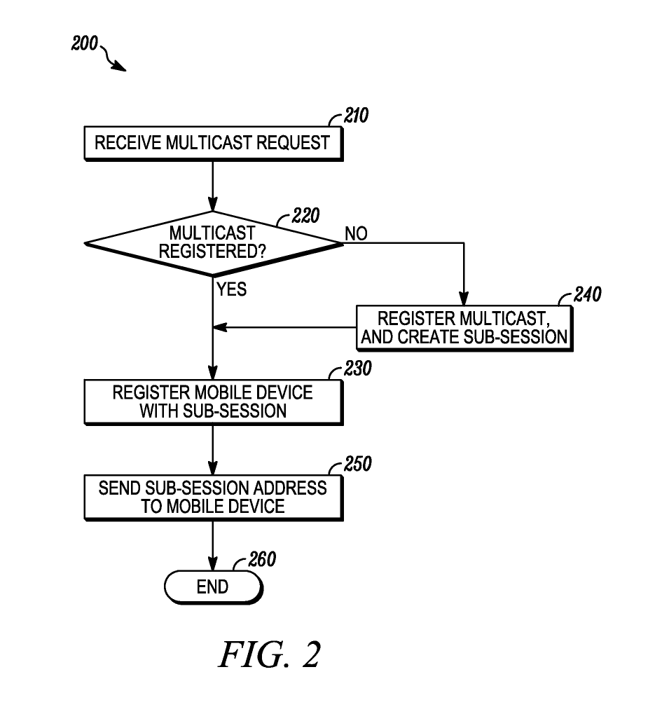

FIG. 2 illustrates a flow chart of an example of a process 200 performed by the HA 150, upon receiving a request to participate in a multicast session from a mobile device. The process 200 starts at step 210, with the receipt of a request to participate in a multicast session, from the mobile device, such as the mobile device 130 of FIG. 1.

Next, in step 220, the HA 150 of FIG. 1 determines whether a sub-session associated with the particular multicast session in which the mobile device wishes to participate has been created, which for the illustrated embodiment comprises determining whether the multicast session is registered. If the multicast session is registered, the process moves on to step 230, otherwise the process moves to step 240.

In step 240, the HA 150 registers the multicast session, for example stores the appropriate multicast address, and creates a sub-session associated with that multicast session. The process then moves to step 230, where the HA 150 registers the mobile device with the sub-session associated with the requested multicast session.

Next, in step 250, the HA 150 sends sub-session details, for example a sub-session address, back to the requesting mobile device. Finally, the process ends at step 260.

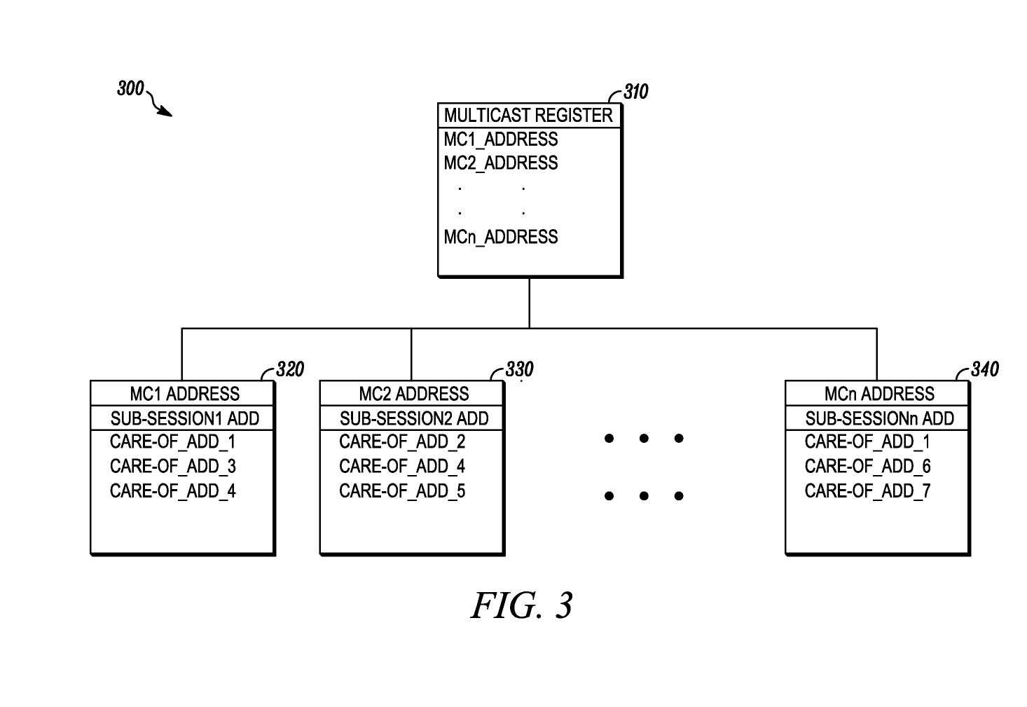

FIG. 3 illustrates an example of a multicast data structure 300 that may be implemented by the HA 150. The data structure 300 comprises a multicast register 310, comprising a list of, for example, multicast addresses relating to multicast sessions for which the HA 150 has received requests from mobile devices.

The data structure 300 further comprises sub-session indexes 320, 330, 340, each corresponding to a multicast address within the multicast register 310. Each sub-session index 320, 330, 340 comprises sub-session details, for example a sub-session address, and, for the illustrated embodiment, a list of care-of-addresses for mobile devices from which the HA 150 received a request for the corresponding multicast session. In this way, when the HA 150 receives a request to participate within a multicast session, the HA 150 registers the mobile device with the sub-session by adding the care-of-address at which the mobile device is registered to the relevant sub-session index 320, 330, 340.

As will be appreciated, the HA 150 may receive requests from a plurality of mobile devices to participate within a particular multicast session, all visiting the same foreign domain, and thereby all registered with the same care-of address. Where this is the case, only a single instance of the care-of address need be included within the relevant sub-session index 320, 330, 340.

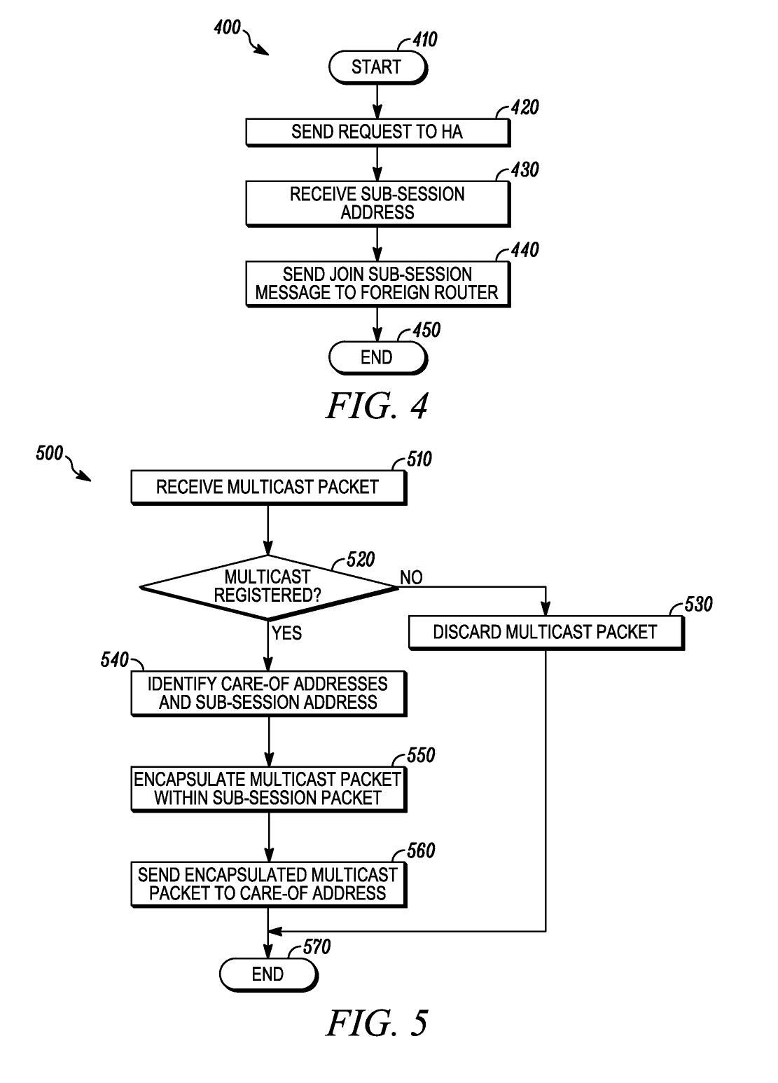

Referring now to FIG. 4, there is illustrated a flow chart of an example of a process 400 performed by a mobile device, such as the mobile device 130 wishing to participate in a multicast session, as part of a method of providing multicast communication.

As previously mentioned, when the mobile device 130 wishes to participate in a multicast session, the mobile device 130 sends a request to the HA 150 to join a multicast session. Consequently, after the process starts at step 410, the mobile device sends a request to the HA 150 in step 420.

The HA 150 subsequently sends details of a sub-session, for example a sub-session address, back to the mobile device 130.

Upon receipt of the sub-session address, in step 430, the mobile device 130 sends a message to the foreign router 140 in FIG. 1, in step 440, informing the foreign router 140 that the mobile device 130 wishes to join the multicast sub-session, and provides the sub-session address thereto. The foreign router 140 then provides multicast routing functionality, as is well known in the art.

Referring now to FIG. 5, there is illustrated a flow chart of an example of a process 500 performed by, for example, the HA 150 upon receipt of a multicast data packet, as part of a method of providing multicast communication. The multicast data packet may have originated from a home client 170 of FIG. 1, or other source, associated with the home domain 110.

The process 500 starts at step 510, when the HA 150 receives a multicast data packet, for example via a router 160 of the home domain 110 of FIG. 1. Next, in step 520, the HA 150 determines whether the multicast session to which the multicast packet corresponds has been registered therewith. For the illustrated embodiment, the HA 150 compares the multicast address of the multicast packet with those stored within its multicast register 310 of FIG. 3, to determine whether a mobile device registered therewith has requested to join that particular multicast session.

If the multicast session, to which the received multicast data packet corresponds, has not been registered with the HA 150, the HA 150 discards the multicast data packet in step 530, and the process ends at step 570.

If the multicast session has been registered, which for the illustrated embodiment is signified by the multicast address of the received multicast data packet being present within the multicast register 310, the next step is to retrieve information relating to a sub-session associated with the multicast session. Therefore, for the illustrated embodiment, the process moves to step 540, where the HA 150 retrieves the corresponding sub-session index 320, 330, 340 and identifies those care-of-addresses to which the multicast data packet is required to be sent. The HA 150 also retrieves the sub-session address.

Having identified those care-of-addresses to which the multicast data packet is to be sent, the HA 150 then encapsulates the multicast data packet within a sub-session packet comprising the sub-session address as the destination address, in step 550.

Next, in step 560, the HA 150, for each care-of-address, encapsulates the sub-session packet within a further packet addressed to the care-of-address, for example within a Mobile Internet Protocol (MIP) packet, and sends it out via, for example, the PSCN.

Once an encapsulated multicast data packet has been sent out for each care-of address, the process ends at step 570.

In this manner, the mobile device will receive multicast sub-session packets. Upon receipt of a sub-session packet, the mobile device is able to de-capsulate the sub-session packet, and retrieve the original multicast packet therefrom.

In order to provide security for multicast data packets, it is envisaged that the HA 150 may encrypt the re-addressed multicast data packet prior to encapsulation, for example using the IPSEC transport protocol, as defined in defined in request for change document RFC 2401 (Security Architecture for the Internet Protocol). In this manner, even where a multicast data packet received from within the home domain is not encrypted, in order for the multicast data packet to successfully reach a mobile device visiting a foreign domain, it must pass through the HA 150 of FIG. 1. Consequently, the HA 150 is able to ensure that any multicast data packets are encrypted prior to leaving the home domain 110 of FIG. 1.

In particular, unlike prior art solutions, security may be afforded not only between the HA and an FA of the foreign domain, for example by way of a MIP tunnel, but also between the FA of the foreign domain and the mobile device.

Furthermore, as will be appreciated by a skilled artisan, by creating a sub-session, the original multicast packet can be encrypted, and then encapsulated within the sub-session packet. In this way, the original multicast packet is encrypted, and does not require, for example, a foreign agent to decrypt the data packet in order to determine the multicast address. Instead, a normal router can receive the sub-session packet, and use its destination address. This provides security for multicast packets leaving the home domain, even when the original multicast packets are not encrypted.

Referring back to FIG. 1, as previously mentioned, when the HA 150 receives a request from one or more mobile devices visiting the foreign domain 120 to join a particular multicast session (original multicast session), the HA 150 creates a sub-session for that multicast session. In accordance with one embodiment, a sub-session is a multicast session of the foreign domain 120. In this manner, when the HA 150 creates a sub-session, the HA 150 creates a multicast session within the foreign domain 120 associated with the original, requested multicast session. For example, the HA 150 registers a new multicast session with a foreign router 140, and receives therefrom a multicast address for the multicast session in the foreign domain 120. The HA 150 then associates the multicast session in the foreign domain 120 with the original, requested multicast session in the home domain 110, as a sub-session thereof.

The HA 150 then provides an address for the multicast session of the foreign domain 120 to the, or each, mobile device, in a form of a sub-session address. The, or each, mobile device, upon receipt of the sub-session address, may then send a request to join the multicast session of the foreign domain 120 to the foreign router 140.

In this manner, when the HA 150 receives a multicast message addressed to the original multicast session address, the HA encapsulates the received multicast message within a data packet addressed to the associated sub-session address, and forwards the encapsulated message to the foreign router 140. Since the sub-session address is the address of a multicast session of the foreign domain 120, which the, or each, mobile device has joined, the foreign router 140 treats the encapsulated multicast message from the HA 150 as a normal multicast message, and distributes it within the foreign domain 120, and thereby to the, or each, visiting mobile device.

As will be appreciated by a skilled artisan, this provides the advantage that, since the sub-session is a multicast session of the foreign domain 120, created in order for the visiting mobile devices to participate in a multicast session of their home domain 110, the problem of a conflict between a home domain 110 multicast session address and a foreign domain 120 multicast session address is substantially alleviated.

Furthermore, the multicast functionality of foreign domains may be fully utilized, substantially alleviating a need for the HA 150 to transmit a multicast message individually to mobile devices visiting the same foreign domain.

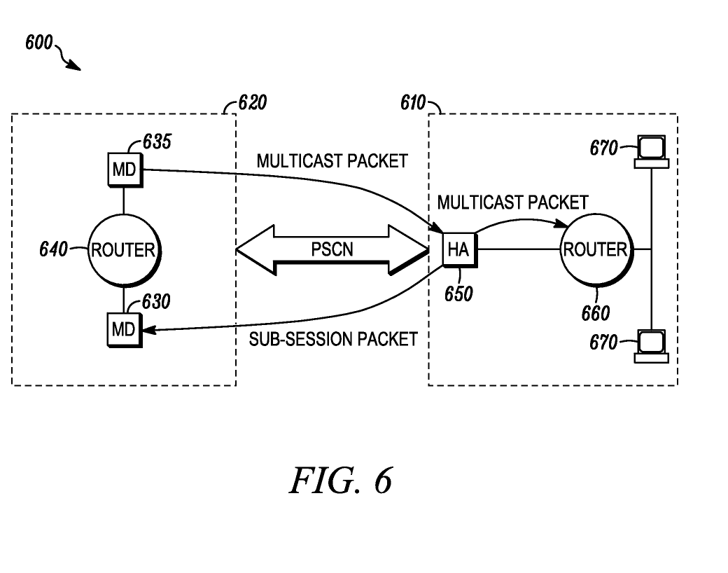

Referring now to FIG. 6, there is illustrated a communication system 600 comprising a home domain 610 and a foreign domain 620, each coupled to a public switched communication network (PSCN), for example the Internet, and accordingly afforded connectivity there between.

A first mobile device 630 and a second mobile device 635, both of which are associated with the home domain 610, are visiting the foreign domain 620, and as such are coupled to a foreign router 640. The home domain 610 comprises a mobility management agent, or home agent (HA) 650, a home router 660 and one or more home clients 670.

The first and second mobile devices 630, 635 participate in a multicast session, and as such the HA 650 has registered the multicast session, created a sub-session and registered the first and second mobile devices 630, 635 with the sub-session, as described above.

For the embodiment illustrated in FIG. 6, the second mobile device 635 is to send a multicast data packet as part of the multicast session. Accordingly, the second mobile device creates the multicast data packet with the multicast address of the multicast session as the destination address. The second mobile device 635 then encapsulates the multicast data packet within a further packet, for example an MIP packet, addressed to the HA 650, and sends it to the foreign router 640 to be sent to its home domain 610. The multicast data packet may also be encrypted, for example using the IPSEC security protocol, prior to being encapsulated within, for example, the MIP packet.

Upon receipt of the encapsulated multicast data packet, the HA 650 de-capsulates the multicast data packet and forwards it on to the home router 660 for distribution within the home domain 610, for example to home clients 670. The HA 650 also determines whether the multicast session to which the multicast data packet corresponds has been registered therewith. If the multicast session has been registered, the HA 650 encapsulates the multicast data packet within a sub-session packet comprising the sub-session address as the destination address, and forwards this to the relevant care-of-addresses, as described above with reference to FIG. 5.

In this manner, even when two mobile devices participating in the same multicast session are visiting the same foreign domain 620, multicast transmissions are still routed via the HA 650. Consequently, the HA 650 is able to substantially maintain the security of multicast transmissions outside of the home domain 610. In particular, the HA 650 may encrypt the multicast message prior to encapsulating it within a sub-session data packet. In this manner, security is afforded between the HA and the, or each, mobile device visiting a foreign domain.

Furthermore, even when a foreign domain does not comprise a foreign agent capable of MIP tunnelling between itself and an HA, security is afforded between the home domain and the foreign domain.

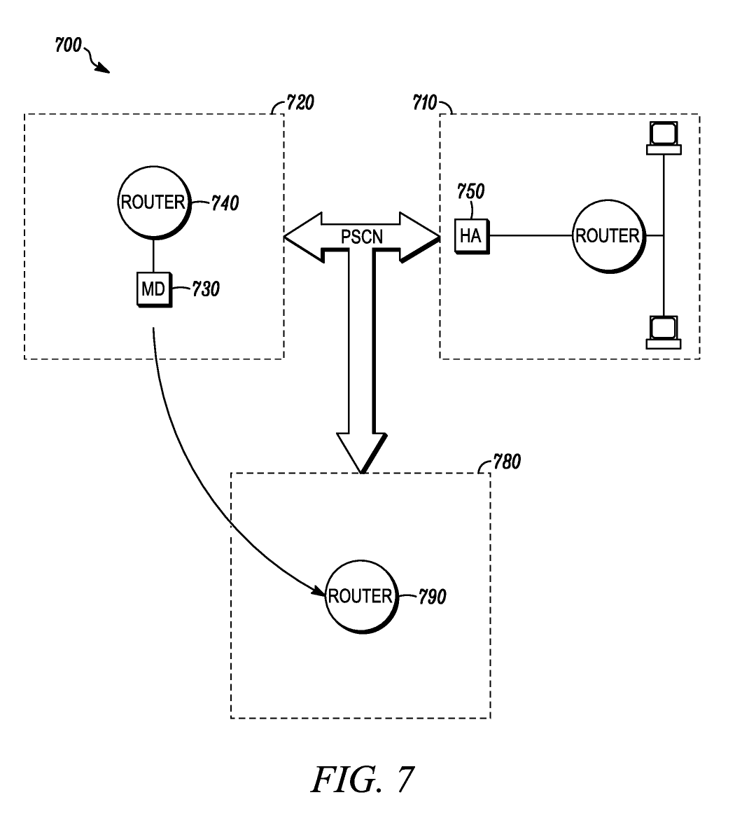

Referring now to FIG. 7, there is illustrated a communication system 700 comprising a home domain 710, a first foreign domain 720, and a second foreign domain 780, each coupled to a public switched communication network (PSCN), for example the Internet, and accordingly afforded connectivity therebetween.

A mobile device 730, associated with the home domain 710, is visiting the first foreign domain 720, and as such is coupled to a foreign router 740 of the first foreign domain 720. The home domain 710 comprises a mobility management agent, or home agent (HA) 750.

As is known, a mobile device may wish to move from one foreign domain to another, for example the mobile device 730 may wish to move from the first foreign domain 720 to the second foreign domain 780. As will be appreciated by a skilled artisan, in order for the mobile device 730 to continue to participate in multicast sessions, a foreign router 790 of the second foreign domain 780 is required to be informed of any such multicast sessions.

Accordingly, when the mobile device 730 moves from the first foreign domain 720 to the second foreign domain 780, the mobile device 730 registers its new care-of-address for the second foreign domain 780 with the HA 750. The mobile device 730 then sends a message to the foreign router 790 of the second foreign domain 780, informing the foreign router 790 that the mobile device 730 wishes to join a multicast sub-session, as created by the HA 750, and provides the sub-session address thereto. The foreign router 790 then provides multicast routing functionality, as is well known in the art.

As previously mentioned, in one embodiment the sub-session is a multicast session within the foreign domain. In this manner, when the mobile device 730 moves from the first foreign domain 720 to the second foreign domain 780, the HA 750 may determine whether a sub-session has already been created for the second foreign domain 780, for example for another mobile device (not shown) visiting the second foreign domain 780. If a sub-session has not already been created for the second foreign domain 780, the HA 750 registers a new multicast session with the foreign router 790, and receives therefrom a multicast address for the multicast session in the foreign domain 780. The HA 750 then associates the multicast session in the foreign domain 780 with the multicast session within the home domain 710, in which the mobile device 730 wants to participate, as a sub-session thereof.

The HA 750 then provides an address for the multicast session of the foreign domain 780 to the mobile device 730, in a form of a sub-session address. The mobile device 730, upon receipt of the sub-session address may then send a request to join the multicast session of the foreign domain 780 to the foreign router 790.

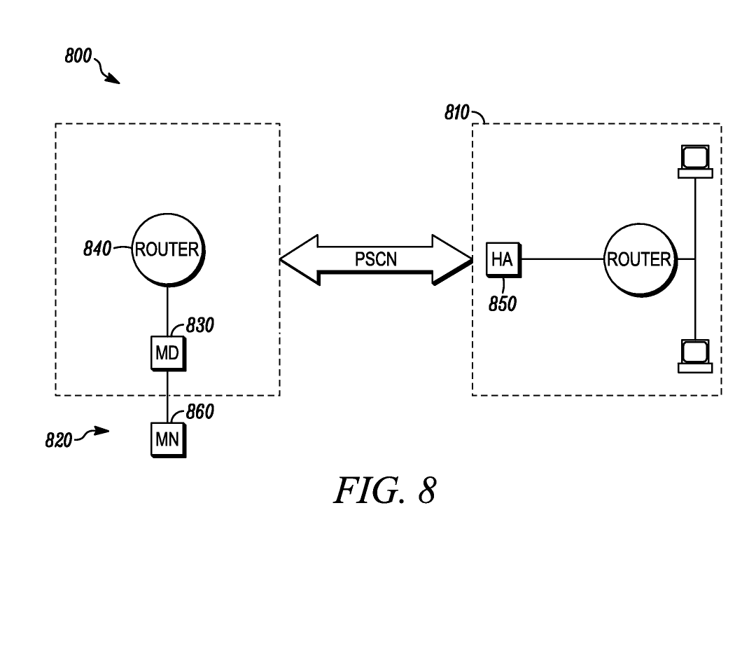

Referring now to FIG. 8, there is illustrated a communication system 800 comprising a home domain 810 and a foreign domain 820, each coupled to a public switched communication network (PSCN), for example the Internet, and accordingly afforded connectivity therebetween.

A mobile device 830, associated with the home domain 810, is visiting the first foreign domain 820, and as such is coupled to a foreign router 840 of the foreign domain 820. The home domain 810 comprises a mobility management agent, or home agent (HA) 850.

A mobile node 860 is coupled to the mobile device 830, and is also associated with the home domain 810. In this manner, the mobile node 860 communicates with the foreign router 840, and thereby the HA 850, via the mobile device 830. For clarity, a mobile node may be a device without MIP capability, for example one that is unable to decrypt encrypted data packets.

In the same manner as for the mobile device 830, the mobile node 860 may wish to join a multicast session. To join a multicast session, the mobile node 860 notifies the mobile device 830 that it wishes to join a multicast session. Upon receipt of such a notification, the mobile device 830 sends a request to join the multicast session to the HA 850, and subsequently joins a multicast sub-session, associated with the multicast session, and created by the HA 850, as described above. In effect, the mobile device 830 joins the multicast session, by way of the multicast sub-session, on behalf of the mobile node 860, and acts as a multicast router therefor.

The mobile device 830 may create a further sub-session, that is to say a sub-session of the multicast sub-session created by the HA 850, or sub-sub-session, and assigns a sub-sub-session IP address thereto, which it provides back to the mobile node 860.

When the mobile device 830 subsequently receives data packets relating to the multicast sub-session, the mobile device 830 de-capsulates the multicast packet from the sub-session data packet, and then re-encapsulates the multicast sub-session data packet within a sub-sub-session data packet comprising the sub-sub-session IP address as the destination address, and then forwards this data packet to the mobile node 860.

In this manner, if the mobile node 860 is, for example, unable to decrypt encrypted packets, the re-encapsulation of the multicast packet enables the mobile device 830 to decrypt the multicast packet on behalf of the mobile node 860.

The mobile device 830 may create a further sub-session by way of registering a new multicast session with the foreign router 840, and receives therefrom a multicast address for the new multicast session in the foreign domain 820. The mobile device 830 then associates the new multicast session in the foreign domain 820 with the multicast sub-session as a sub-sub-session.

The mobile device 830 then provides the address of the new multicast session of the foreign domain 820 to the mobile node 860, in a form of a sub-sub-session address. The mobile node 860, upon receipt of the sub-sub-session address may then send a request to join the new multicast session of the foreign domain 820 to the foreign router 840.

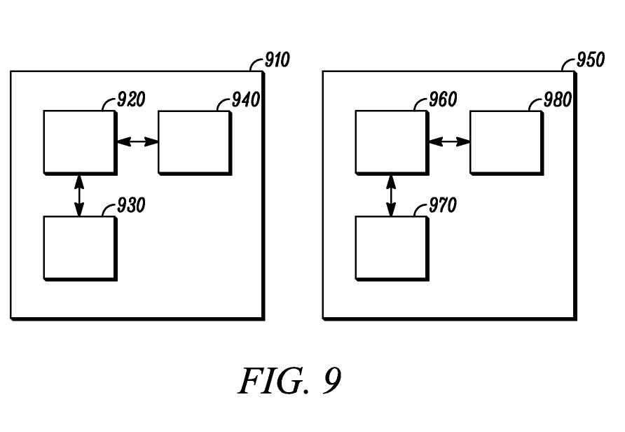

As will be appreciated by a skilled artisan, a mobile device and a mobile management agent according to any embodiment described herein may each comprise logic and memory elements for enabling the implementation of the invention. By way of example, and as illustrated in FIG. 9, a mobile device 910 and mobile management agent 950 each may comprise processing devices 920, 960 adapted to implement a method of providing a multicast communication as described herein. The mobile device 910 and mobile management agent 950 may also comprise computer-readable storage elements 930, 970, and communication components 940, 980 adapted for transmitting and/or receiving data packets, such as TCP/IP data packets, MIP data packets, etc.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms ‘comprises,’ ‘comprising,’ ‘has’, ‘having,’ ‘includes’, ‘including,’ ‘contains’, ‘containing’ or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by ‘comprises . . . a’, ‘has . . . a’, ‘includes . . . a’, ‘contains . . . a’ does not, without more constraints, preclude the existence of additional identical elements in the process, method, article, or apparatus that comprises, has, includes, contains the element. The terms ‘a’ and ‘an’ are defined as one or more unless explicitly stated otherwise herein. The terms ‘substantially’, ‘essentially’, ‘approximately’, ‘about’ or any other version thereof, are defined as being close to as understood by one of ordinary skill in the art. The term ‘coupled’ as used herein is defined as connected, although not necessarily directly and not necessarily mechanically. A device or structure that is ‘configured’ in a certain way is configured in at least that way, but may also be configured in ways that are not listed.

It will be appreciated that some embodiments may be comprised of one or more generic or specialized processors (or ‘processing devices’) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for providing multicast communication described herein. The non-processor circuits may include, but are not limited to, a radio receiver, a radio transmitter, signal drivers, clock circuits, power circuits, and user input devices. As such, these functions may be interpreted as steps of a method to multicast communication described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a ‘processing device’ for purposes of the foregoing discussion and claim language.

Moreover, an embodiment can be implemented as a computer-readable storage element having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method of providing multicast communication between a home domain and a mobile device visiting a foreign domain; the method characterised by the steps of:
receiving a request to participate in a multicast session from the mobile device visiting the foreign domain;
determining whether a sub-session associated with the multicast session in which the mobile device wishes to participate has been created; and if not, initiating a creation of a multicast session within the foreign domain to define a sub-session associated with the requested multicast session;
registering the mobile device, from which the request was received, with the sub-session associated with the requested multicast session;
providing a sub-session address to the mobile device; and
upon subsequent receipt of a multicast packet corresponding to the multicast session,
encapsulating the received multicast packet within a sub-session packet, the sub-session packet comprising the sub-session address as its destination address, and
sending the sub-session packet to a care-of address for the mobile device.

2. The method of claim 1 further characterised by encrypting the multicast packet prior to encapsulating it within a sub-session packet

3. The method of claim 1 further characterised by registering the mobile device with the sub-session comprises associating the care-of address for the mobile device with the sub-session.

4. The method of claim 1 further characterised by:
upon receipt of a multicast packet, determining whether a multicast session to which the multicast packet corresponds has been registered; and
if the multicast session to which the multicast packet corresponds has been registered, encapsulating the received multicast packet within a sub-session packet, and sending the sub-session packet to the care-of address for the mobile device.

5. The method of claim 1 further characterised by, upon receiving a multicast packet corresponding to the multicast session, retrieving care-of addresses for mobile devices registered with the sub-session, and for each care-of address, encapsulating the sub-session packet within a further packet addressed to the care-of address.

6. A mobile management agent associated with a home domain and comprising logic arranged to provide multicast communication between the home domain and a mobile device, the mobile management agent characterised by:
logic arranged to receive a request to participate in a multicast session from the mobile device visiting a foreign domain;
logic arranged to determine whether a sub-session associated with the multicast session in which the mobile device wishes to participate has been created; and if not, the logic initiates a creation of a multicast session within the foreign domain to define a sub-session associated with the requested multicast session;
logic for registering the mobile device, from which the request was received, with the sub-session associated with the requested multicast session;
logic for providing a sub-session address to the mobile device; and, upon subsequent receipt of a multicast packet corresponding to the multicast session,
logic for encapsulating the received multicast packet within a sub-session packet, the sub-session packet comprising the sub-session address as its destination address, and
logic for sending the sub-session packet to a care-of address for the mobile device.

7. The mobile management agent of claim 6 further characterised by logic for encrypting the multicast packet prior to encapsulating it within the sub-session packet.

8. The mobile management agent of claim 6 further characterised by the logic for associating the care-of address for the mobile device with the sub-session.

9. The mobile management agent of claim 6 further characterised by, upon receipt of a multicast packet, logic for determining whether a multicast session to which the multicast packet corresponds has been registered; and if the multicast session to which the multicast packet corresponds has been registered, logic encapsulates the received multicast packet within a sub-session packet, and sends the sub-session packet to the care-of address for the mobile device.

10. The mobile management agent of claim 6 further characterised by, upon receipt of a multicast packet corresponding to the multicast session, logic retrieves a plurality of care-of addresses for mobile devices registered with the sub-session, and for each care-of address, logic encapsulates the sub-session packet within a further packet addressed to a respective care-of address.
